(19) United States
(12) Patent Application Publication
(10) Pub. No.: US 2021/0114911 A1
(43) Pub. Date: Apr. 22, 2021

(54) CATIONIC CLAY COMPOSITION FOR TREATING WASTEWATER AND METHOD OF USING SAID COMPOSITION

(71) Applicants: William J Cox, Indialantic, FL (US); Billy Ray White, Orlando, FL (US)

(72) Inventors: William J Cox, Indialantic, FL (US); Billy Ray White, Orlando, FL (US)

(21) Appl. No.: 17/251,754

(22) PCT Filed: Jun. 11, 2019
(86) PCT No.: PCT/US19/36595

§ 371 Date: Dec. 11, 2020

Related U.S. Application Data
(63) Continuation of application No. PCT/US19/15436, filed on Jan. 28, 2019.
(60) Provisional application No. 62/683,066, filed on Jun. 11, 2018.

(51) Int. Cl. C02F 9/00

(52) U.S. Cl. CPC C02F 9/00; C02F 1/5245

(57) ABSTRACT

A cationic mineral composition for treating wastewater is provided. The composition assists with flocculating out biomass suspended within the wastewater. The cationic clay composition may be mixed with the wastewater undergoing a wastewater treatment process at numerous injection sites. Mixing the cationic clay composition with wastewater at these injection sites may provide different benefits, wherein these benefits are dependent on the point at which the wastewater is along the wastewater treatment process. The cationic clay composition may be added at one injection site or multiple injection sites, depending on a determination made by the operator.

### CROSS REFERENCES

This application claims the benefit of U.S. Provisional Application No. 62/683,066, filed on Jun. 11, 2018, and international application No. PCT/US2019/015436, filed on Jan. 28, 2019, which applications are incorporated herein by reference.

### FIELD OF THE DISCLOSURE

The subject matter of the present disclosure refers generally to a composition for treating wastewater and a method of using the composition.

### BACKGROUND

Current wastewater treatment plants use large amounts of harsh chemicals to both flocculate dissolved, suspended, and colloidal biosolids and disinfect the wastewater before it is released into a receiving stream. These chemicals enter the environment and build up over time, damaging the ecosystem into which the wastewater is released. For instance, chlorine used as a disinfectant in wastewater treatment plants can adversely affect wildlife if it reaches the receiving stream. Chlorine gas can also have an adverse effect on the atmosphere. In particular, chlorine gas can adversely affect the ozone layer as chlorine free radicals react readily with ozone in the atmosphere to create halogen oxides. Inadequately treated effluent requires larger amounts of chlorine for disinfection, which may also form hazardous carcinogenic trichloromethyl compounds. Additionally, chemicals currently heavily used in wastewater treatment can be expensive as well as pose health risks to the workers who operate the wastewater treatment plants. For instance, the coagulating polymers often used during wastewater treatment may cause skin, eye, respiratory, and gastrointestinal irritation to any worker who may come in contact with the coagulating polymer.

Further, current methods of wastewater treatment that use these harsh chemicals often require additional work to prevent damage to the various systems of the wastewater treatment plant or to create quality biosolids that may be reused to provide food for microorganisms of the system. For instance, the coagulating polymers used to create sludge from the dissolved, suspended, and colloidal solids can form large masses that may place strains on the various systems of the wastewater treatment plant if not monitored. Coagulating polymers also are not used to remove sulfur-containing compounds early in the treatment process that may otherwise form hydrogen sulfide and sulfuric acid as microorganisms break these sulfur containing compounds down during treatment. Utilization of Aluminum Sulfate, used for both settleability and screening, also adds sulfur-forming compounds during wastewater treatment, which further exacerbates hydrogen sulfide and sulfuric acid issues. Sulfuric acid can be particularly devastating to a wastewater treatment facility as it can readily corrode the concrete and steel pipes frequently used during plant operations. Aluminum sulfate is hazardous to the plant's microecology, which is necessary for bacterial decomposition of raw sewage. Additionally, sludge produced by systems using the coagulating polymers must often undergo centrifugation in order to create quality biosolids that may be reused by the wastewater treatment plant, which further increases the operating cost. Activated sludge returned to the wastewater treatment process, now containing these harmful chemicals, will eventually kill off the microbes (necessary for sludge decomposition) during secondary treatment, causing inadequate nitrification/denitrification that ultimately causes a decrease in the effectiveness of the wastewater treatment process at the plant.

Accordingly, there is a need in the art for an improved composition for treating wastewater that may reduce or eliminate chemicals typically used in wastewater treatment plants and a method of using the composition to treat wastewater.

### SUMMARY

The present invention provides compositions for treating wastewater and a method of using the compositions to treat wastewater in accordance with the independent claims. Preferred embodiments of the invention are reflected in the dependent claims. The claimed invention can be better understood in view of the embodiments described and illustrated in the present disclosure, viz. in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

In accordance with the present disclosure, a composition for treating wastewater is provided, as well as a method for using the composition to treat wastewater. The composition is a cationic mineral composition comprising at least 70 weight percent kaolinite and between 5 and 25 weight percent titanium dioxide. The composition has an average particle size of 25 to 150 microns, and preferably 25 to 75 microns. The composition may optionally be formulated as a slurry of kaolinite and titanium dioxide in water. When using the composition to treat wastewater, the process reduces or eliminates the need to utilize aluminum sulfate, coagulating polymers, chlorine, and other chemicals currently used to treat wastewater that degrade effluent quality and pollute receiving waters. The composition is added to wastewater in an amount sufficient to promote flocculation to an extent in which the floc contains at least 50% of the biomass within 10 minutes of adding the cationic mineral composition. Generally, the cationic mineral composition, which is a cationic clay composition, causes biomass to floc out of wastewater. In some embodiments, the floc formed in the process may be recycled. Systems in which the composition may be utilized may comprise a wastewater collection apparatus, preliminary treatment apparatus, secondary treatment apparatus, digestor apparatus, and disinfection apparatus. The wastewater treatment systems described herein generally refer to activated sludge processes, but one skilled in the art will recognize that the methods employed herein may be used for other wastewater treatment systems. Wastewater is collected by the systems and a cationic mineral composition is added to the wastewater at one or more injection sites, which causes biomass within the wastewater to flocculate out. Some systems may further comprise a sedimentation apparatus that clarifies wastewater and sludge water of the system. Other systems may further comprise a flow equalization apparatus that regulates flow throughout the systems. The various systems may also comprise a denitrification apparatus that removes nitrogen from the wastewater. A coagulating polymer may optionally be added to the wastewater to assist the cationic mineral composition in flocculating out the biomass.

Wastewater may be defined as water containing suspended organic solids. If wastewater is not treated before being transported to receiving waters, the organic solids may deplete oxygen supplies in the receiving stream, which could cause fish kills and become a source of unpleasant odors, whereas wastewater containing heavy metals may cause serious lasting damage to environments were the heavy metals not removed prior to being released to the receiving waters. Wastewater can be treated by adding a flocculating compound that causes dissolved, suspended, and colloidal biomass contained in the wastewater to flocculate out to form sludge containing large numbers of microorganisms that may consume biomass. A cationic clay composition is used as the flocculating compound. A coagulating polymer may optionally be used to floc out dissolved, suspended, and colloidal biomass. In one optional embodiment, the coagulating polymer may be mixed with the cationic clay composition prior to being mixed with wastewater. The cationic clay composition may be mixed with a volume of water to create a slurry before addition to the wastewater. In some instances, addition as a slurry may increase the effectiveness of the cationic clay composition and decrease turbidity of the resulting sludge water.

Wastewater is collected by the wastewater collection apparatus of the system. The wastewater collection apparatus may comprise lateral lines, main lines, manholes, gravity sewer lines, lift stations, and force mains. All of these systems work together to provide wastewater treatment plants for treating the wastewater produced by residential, commercial, and industrial areas within the plant's jurisdiction. Once the wastewater has been collected, the preliminary treatment apparatus is designed to screen out large, entrained, suspended, and floating solid pollution. These solids may include wood, cloth, paper, plastics, garbage, and fecal matter, or similar solid materials, or any combination thereof. Solids may be screened out of the wastewater by passing the wastewater through coarse screens and fine screens. In some embodiments, comminutors and grinders may be used to grind and shred solids into a smaller size. The preliminary treatment apparatus may also be designed to screen out heavy inorganic matter called grit. Inorganic material that may be categorized as grit includes, but is not limited to, sand, gravel, metal, and glass, or any combination thereof.

After the byproducts have been removed, the secondary treatment apparatus is designed to mix the wastewater and cationic clay composition in a way such that these floc out of suspension as well as increase oxygen levels for the microorganisms within the sludge water that are breaking down the biomass. Secondary treatment of the wastewater with the cationic clay composition preferably takes place in an oxidation ditch reactor or a sequence batch reactor. Alternatively, other secondary treatments may be utilized, including, but not limited to, an extended aeration reactor, a contact stabilization reactor, a fixed film reactor, a plug flow reactor, or any combination thereof. Secondary treatment removes soluble organic matter and any remaining suspended and/or colloidal biomass that may have escaped preliminary treatment. Removal of soluble organic matter and suspended and/or colloidal biomass during secondary treatment may be accomplished via microbial processes that consume the organic waste and convert it into carbon dioxide, water, and energy.

An oxidation ditch system may be defined as a modified activated sludge wastewater treatment process comprising an oxidation ditch reactor that enables the system to use long solids retention times (SRTs) to remove biomass and increase its ability to remove both nitrogen and phosphorous. Oxidation ditch reactors typically comprise a basin having a ring, oval or horseshoe shape. This basin may have a single or multichannel configuration. Mounted aerators (mechanical aeration) circulate the wastewater within the basin as well as facilitate oxygen transfer and aeration. A sequence batch system may be defined as a modified activated sludge wastewater treatment process comprising at least one aeration tank that bubbles oxygen through wastewater and activated sludge in batches to reduce dissolved and suspended and/or colloidal biomass. Equalization, aeration, and clarification can all be achieved using a single batch reactor. However, two or more batch reactors may be used in sequence to optimize results.

The systems may further comprise a sedimentation apparatus that allows wastewater and/or sludge water to clarify via the settling of dissolved, suspended, and colloidal biomass via flocculation. The settling of the dissolved, suspended, and colloidal biomass in a modified activated sludge wastewater treatment process results in clearer wastewater and/or supernatant as well as activated sludge. The system may use a sedimentation apparatus before secondary treatment or after secondary treatment. After secondary treatment, the supernatant may be treated by the disinfection apparatus to create a treated effluent, which may be removed from the wastewater treatment plant by discharging the effluent to the receiving waters. The supernatant may be treated by the disinfection apparatus using several techniques, including, but not limited to, chlorination, ozonation, and ultraviolet disinfection.

The use of the cationic clay composition during the wastewater treatment process can increase the effectiveness of treatment depending on the point at which the cationic clay composition is added to the wastewater in the treatment process. The point at which addition of the cationic clay composition to the wastewater is necessary varies by system and conditions. For instance, it may sometimes be necessary to add the cationic clay composition to wastewater immediately after collection to remove ammonia and sulfur-containing compounds early in the treatment process. For instance, it may be necessary to add the cationic clay composition to the wastewater before secondary treatment or during secondary treatment. In other systems, the addition of the cationic clay composition may come after preliminary treatment due to the nature of the reactor. Further, an operator may decide whether or not the cationic clay composition should be added to wastewater at certain points depending on desired results. For instance, the operator may decide to add the cationic clay composition to sludge removed from the sedimentation apparatus to create a more compact product in situations where the sludge is not sufficiently compact.

The foregoing summary has outlined some features of the process of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and process disclosed herein. Those skilled in the pertinent art should also realize that such equivalent designs or modifications do not depart from the scope of the process of the present disclosure.

### DESCRIPTON OF THE DRAWINGS

These and other features, aspects, and advantages of the present disclosure will become better understood with regard to the following description, appended claims, and accompanying drawings where:

FIG. 1 is a schematic of a wastewater treatment in which techniques described herein may be implemented.

FIG. 2 is a schematic of a wastewater treatment plant in which techniques described herein may be implemented.

FIG. 3 is a flow chart illustrating certain method steps in accordance with the principles of the present disclosure.

FIG. 4 is a flow chart illustrating certain method steps in accordance with the principles of the present disclosure.

### DETAILED DESCRIPTION

In the Summary above and in this Detailed Description, and the claims below, and in the accompanying drawings, reference is made to particular features, including method steps, of the invention as claimed. In the present disclosure, many features are described as being optional, e.g. through the use of the verb “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features. It is to be understood that the disclosure in this specification includes all possible combinations of such particular features. For example, where a particular feature is disclosed in the context of a particular aspect or embodiment, or a particular claim, that feature can also be used, to the extent possible, in combination with/or in the context of other particular aspects or embodiments, and generally in the invention as claimed.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “suspended” and grammatical equivalents thereof may refer to all pollutants in wastewater regardless of form. For instance, dissolved, suspended, and colloidal biomass may be suspended in wastewater. As used herein, the term “flocculant” and grammatical equivalents thereof may refer to the substances that promote the clumping of particulate pollutants suspended within wastewater. For instance, a cationic clay composition may promote the clumping of biomass suspended throughout the wastewater to form activated sludge. As used herein, the term “sludge water” and grammatical equivalents thereof may refer to wastewater containing activated sludge.

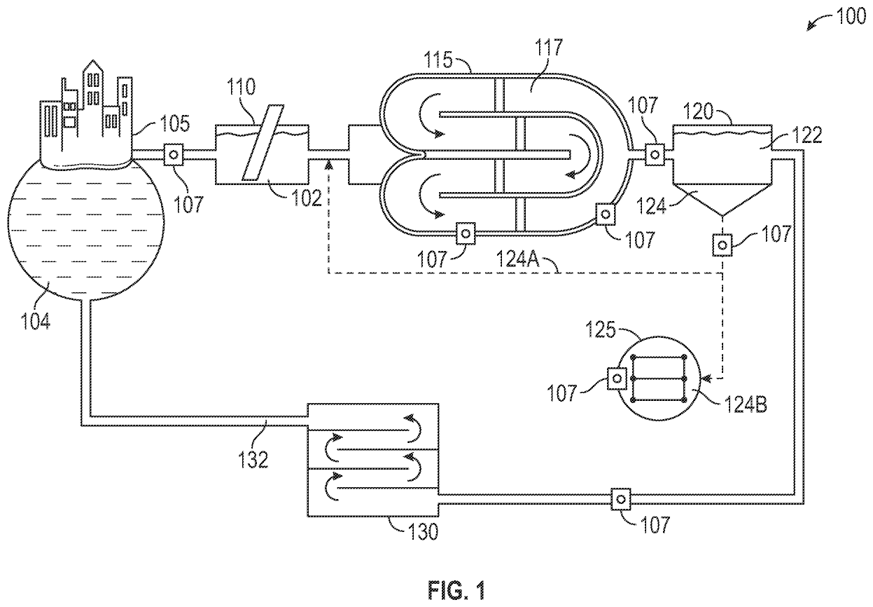

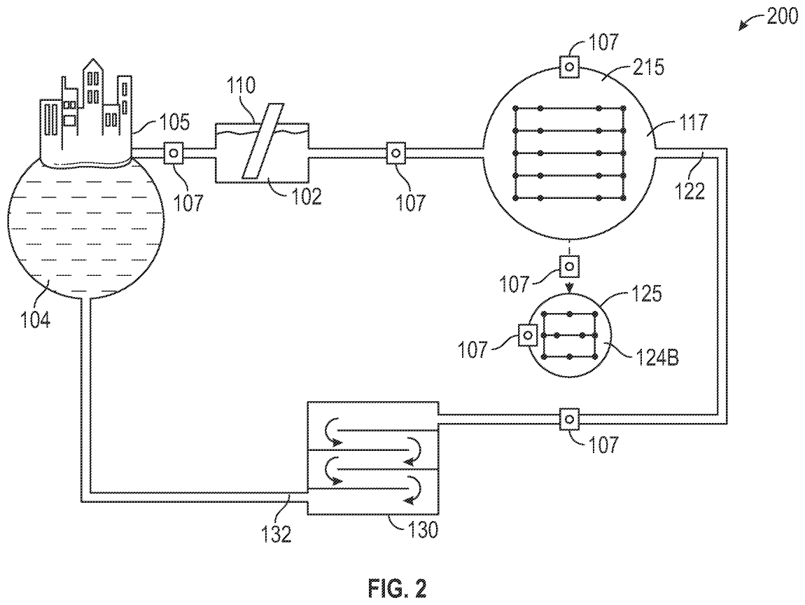

FIGS. 1-4 illustrate wastewater treatment systems and methods for treating wastewater 102 utilizing a cationic clay composition that acts as a flocculant. As illustrated in FIGS. 1-2, systems in which the mineral composition may be utilized may generally comprise a wastewater collection apparatus 105, preliminary treatment apparatus 110, secondary treatment apparatus 115 and 215, digestor apparatus 125, and disinfection apparatus 130. In an optional embodiment, the wastewater treatment systems are activated sludge 124 systems. Wastewater 102 is collected by the systems and a cationic clay composition is added to the wastewater 102 at numerous injection sites 107, which causes biomass within the wastewater 102 to flocculate out. In one optional embodiment, the systems may further comprise a sedimentation apparatus 120 (clarifier). In another optional embodiment, the system may further comprise a flow equalization apparatus. In yet another optional embodiment, the system may further comprise a denitrification apparatus. A coagulating polymer may be added to the wastewater 102 to assist the cationic clay composition in precipitating out biomass.

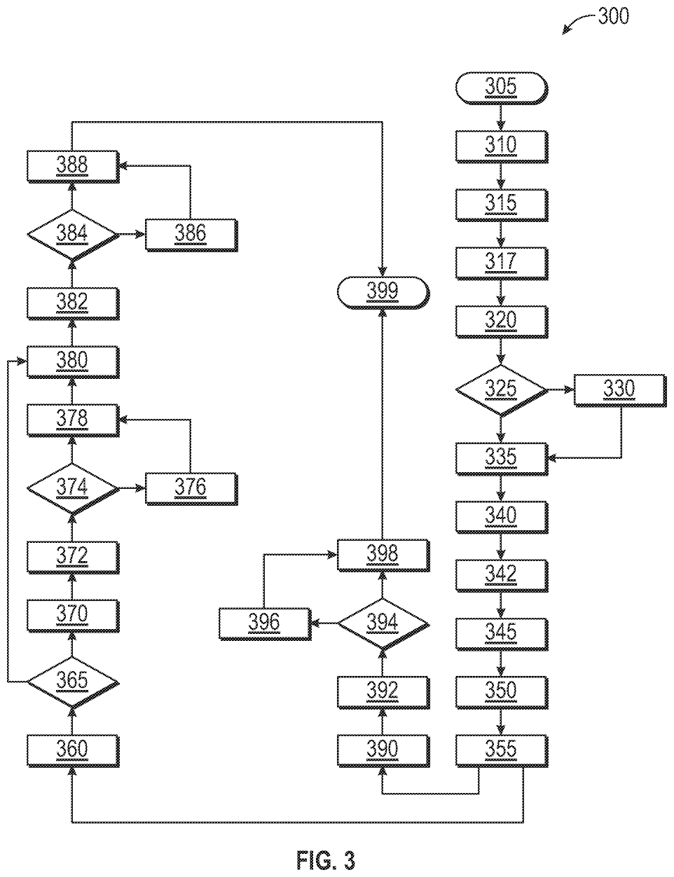

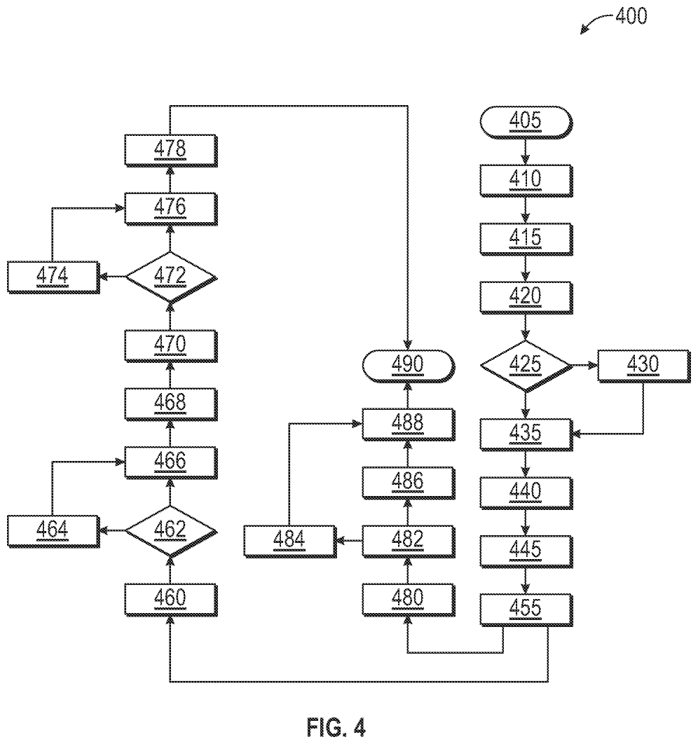

Various method steps for utilizing the present composition for the treatment of wastewater may be carried out by an operator using the systems shown in FIGS. 1-2. FIG. 1 is an illustrative diagram of an oxidation ditch system 100, wherein the oxidation ditch system 100 is an activated sludge wastewater treatment plant that agitates/aerates wastewater 102 via an oxidation ditch reactor 115. FIG. 2 is an illustrative diagram of a sequence batch system 200, wherein the sequence batch system 200 is an activated sludge wastewater treatment plant that agitates/aerates wastewater 102 via a sequence batch reactor 215. FIGS. 3-4 illustrate methods that may be carried out by an operator using the systems of FIGS. 1-2, respectively.

Wastewater 102 may be defined as water having pollution suspended throughout the water. There are typically four types of pollution that may be in wastewater 102: organic, inorganic, thermal, and radioactive. Domestic wastewater 102 contains a large amount of organic waste, which is pollution that mainly comes from animal or plant sources. Bacteria and other microorganism can consume organic waste. Some industrial organic waste comes from vegetable and fruit packing, dairy processing, meatpacking, tanning, poultry oil, paper mills, wood, and other commercial activity. Domestic wastewater 102 also contains inorganic materials such as sand, salt, iron, calcium, and other materials which are only slightly affected by the actions of microorganisms. Industrial wastewater 102 contains inorganic material such as heavy metals (chromium, cadmium, lead, molybdenum, etc.), gravel, and grit. The first indication that a strong toxic industrial discharge has entered the wastewater treatment plant is an increase in oxygen concentration in the aeration basin. The oxygen concentration may increase because microorganisms have been killed, thereby reducing the amount of oxygen being consumed. Thermal waste is heated waste from cooling processes used by industry and thermal power stations. Radioactive waste usually comes from a controlled source, but could come from hospitals, research laboratories, toxic disposal industries, and nuclear power plants. If wastewater 102 is not treated before being transported to receiving waters 104, the organic solids may deplete oxygen supplies in the receiving waters 104, which could cause fish kills and become a source of unpleasant odors.

Wastewater can be treated by adding a flocculating mineral composition that causes biomass suspended throughout wastewater 102 to floc out and create sludge 124. The mineral composition functions only as a flocculant and may optionally be used in combination with a coagulant. The flocculating composition mixed with the wastewater 102 to form sludge 124 is a cationic mineral composition comprising at least 70 weight percent kaolinite and between 5 and 25 weight percent titanium dioxide. Preferably, the composition comprises at least 90 weight percent kaolinite and between 5 and 10 percent titanium dioxide. The composition has an average particle size of 25 to 150 microns, and preferably 25 to 75 microns. The kaolinite has a pKₐ value of about 4.5 along the edge of its particles and a pKₐ value of about 6.5 on the face of its particles. When using the composition to treat wastewater, the process reduces or eliminates the need to utilize aluminum sulfate, coagulating polymers, chlorine, and other chemicals currently used to treat wastewater that degrade effluent quality and pollute receiving waters. The composition is added to wastewater in an amount sufficient to promote flocculation to an extent in which the floc contains at least 50% of the biomass within 10 minutes of adding the cationic mineral composition.

The cationic clay composition is preferably mixed at a rate of at least 0.3 grams per liter (about 0.0025 pounds per gallon) of wastewater depending on the type of wastewater treatment plant, type of wastewater received (industrial or residential), and amount of biomass present within the wastewater. The amount added may range from about 0.3 grams per liter to about 2 grams per liter, depending on the particular application. For instance, a wastewater treatment plant that processes 100,000 gallons of wastewater a day may use at least 250 pounds of cationic clay composition to promote flocculation. A coagulating polymer may optionally be mixed with the wastewater 102 to assist the cationic clay composition in floccing out suspended biomass. In one optional embodiment, the coagulating polymer is mixed with the cationic clay composition prior to being mixed with wastewater 102. The cationic clay composition may be mixed with a volume of water to create a slurry before addition to the wastewater 102. In some instances, addition as a slurry may increase the effectiveness of the cationic clay composition and decrease turbidity of the resulting sludge water 117. When mixed with water, the resulting slurry may be at least eighty combined weight percent kaolinite and titanium dioxide and up to twenty weight percent water.

Wastewater 102 is collected by the wastewater collection apparatus 105 of the system. The wastewater 102 is preferably received by the plant from the wastewater 102 point of origin quickly to prevent septic conditions. The various pipes and open channels of the wastewater collection apparatus 105 are often constructed of concrete, vitrified clay, brick, metals, and polymers. The designed flows of a wastewater collection apparatus 105 vary greatly depending on factors ranging from population, topography of the area, rainfall, and other factors. Generally, the hydraulic design of the wastewater collection apparatus 105 has peak flow velocities high enough to prevent sedimentation and low enough to prevent erosion. The wastewater collection apparatus 105 may comprise lateral lines, main lines, manholes, gravity sewer lines, lift stations, and force mains. All of these systems work together to provide wastewater treatment plants the wastewater 102 produced by residential, commercial, and industrial areas within the plant's jurisdiction. Some wastewater collection apparatuses 105 may also carry storm runoff. Lateral lines may be defined as pipes or open channels that carry waste from residential areas and businesses. Main lines may be defined as large pipes or open channels that collect the sewage from the lateral lines. Manholes may be defined as junctions of intersecting main lines that have entry ports that allow for inspection of the wastewater collection apparatus 105. Gravity sewer lines may be defined as pipes or open channels that carry wastewater 102 collected by main lines to a lower elevation via gravity. Lift stations may be defined as wastewater collection facilities that use pumps to lift the wastewater 102 to a higher elevation or a treatment plant. Force mains may be defined as pipes or open channels used to carry wastewater 102 from a lift station to a treatment plant. When the present cationic clay composition is injected into the wastewater during the wastewater collection, it is preferably added in powder form; however, it may be added in slurry form as well.

Once the wastewater 102 has been collected, the preliminary treatment apparatus 110 is designed to screen out large, entrained, suspended, and floating solids. These solids may include wood, cloth, paper, plastics, garbage, and fecal matter, or any combination thereof. Solids may be screened out of the wastewater 102 by passing the wastewater 102 through coarse screens and fine screens. A course screen may be defined as a mechanical filter comprising a series of parallel steel bars spaced between one and three inches apart. The bars are typically placed in a vertical position relative the flow; however, the bars may be placed at other angles. Coarse screens may be cleaned manually or may comprise automatic cleaning mechanisms. Fine screens may be defined as a mechanical filter comprising wire cloth, wedge wire elements, or perforated plates having openings generally no larger than 0.25 inches. Fine screens may be static, rotatory drum, or step, and are used to screen out solid particulates. Solids removed from the influent wastewater 102 are called screenings, which may be disposed of via incineration or burial. In some embodiments, comminutors and grinders may be used to grind and shred solids into a smaller size. A comminutor may comprise a slotted rotating cylinder comprising a plurality of blades that cuts up solids suspended within the wastewater 102 too large to pass through the slots. Grinders may comprise a plurality of counterrotating intermeshing cutters that trap and shear wastewater 102 solids into a consistent particle size.

The preliminary treatment apparatus 110 may also be designed to screen out heavy inorganic matter called grit. Inorganic material that may be categorized as grit includes, but is not limited to, sand, gravel, metal, and glass, or any combination thereof. Removal of grit may be accomplished via aerated grit chambers, vortex removal, detritus tanks, horizontal flow grit chambers, and cyclonic inertial separation. An aerated grit chamber may be defined as an apparatus that causes wastewater 102 to flow in a spiral pattern by introducing air into one side of the chamber. Heavier grit particles diverge from the spiral streamline and settle at the bottom of the chamber, which may be collected at a later time. Vortex removal may be defined as a system that introduces wastewater to a tank in a tangential fashion such that a vortex is created. Gravity causes the grit to settle at the bottom of the tank and the wastewater 102 exits at the top, thus removing the grit from the wastewater 102. A detritus tank may be defined as a short-term settling tank. The wastewater 102 in the tank is kept at a constant level, and grit is removed from the bottom of the tank periodically where it is subsequently washed to remove organic matter. A horizontal flow grit chamber may be defined as a channel that allows grit to settle at the bottom and lighter particles to remain suspended in the wastewater 102. A constant upstream velocity of approximately one ft/sec may be used to allow settling while keeping the lighter biomass suspended. Flow rate in a horizontal flow grit chamber may be controlled via weirs or control sections. A hydrocyclone may be defined as a centrifuge designed to separate heavier grit from the lighter organic solids. Grit collects on the sides of the hydrocyclone, whereas lighter biomass may be removed from the center.

In another optional embodiment, the system may further comprise a flow equalization apparatus that controls flow velocities of wastewater 102 in a wastewater treatment plant. Flow equalization apparatuses generally comprise a tank, flow pumps, and flow controls. The flow equalization apparatus may be situated to store wastewater 102 after undergoing preliminary treatment because treatment processes generally work more efficiently with a steady flow rate. The tank provides storage for wastewater 102 moving through the system. The tank is large enough to hold the wastewater 102 arriving during a peak period and release that wastewater 102 to the rest of the wastewater treatment plant via the flow pumps. The flow controls dictate the flow rate of the flow pumps. This allows a flow equalization apparatus to supply additional water to the wastewater treatment system when it is arriving less rapidly than desired and reduce the flow when wastewater is arriving more rapidly than desired. Use of a flow equalization controls the flow through each stage of the treatment system, allowing adequate time for the physical, biological and chemical processes to take place. It also prevents solids and organic material from being forced out of the treatment process during peak usage.

In yet another optional embodiment, the system may further comprise a nitrogen removal apparatus that removes nitrogen compounds from the system. A nitrogen removal apparatus uses both nitrification and denitrification to remove nitrogen from the system. The system uses microorganisms that perform both nitrification and denitrification on nitrogen containing compounds. Nitrification is a process in which ammonia is converted to nitrates by aerobic organisms. Denitrification is a process in which nitrates are reduced to gaseous nitrogen by anaerobic organisms. Because the organisms that perform denitrification will metabolize available oxygen before nitrates, it is important that oxygen concentrations are low in order for denitrification to take place. The denitrification process also requires an appropriate amount of carbon containing compounds that may act as an energy source for the anaerobic organisms so that they may perform denitrification. As such, a nitrogen removal apparatus generally comprises at least two tanks in which an aerobic zone and an anaerobic zone may be implemented.

Denitrification apparatuses can have an anaerobic zone prior to an aeration zone or after an aeration zone. When wastewater 102 and sludge 124 enter a denitrification apparatus having an anoxic zone before an aeration zone, nitrate produced in the aerobic zones by nitrification is recycled back to the anoxic zones for denitrification. This process enables the use of the organic carbon source that is available in the influent for denitrification. Since nitrification is located after denitrification, nitrate is present in the effluent. Effluent produced by wastewater treatment plants having a pre-denitrification process will typically have organic nitrogen concentrations ranging from 6 to 10 mg N L⁻¹. When wastewater 102 and sludge 124 enter a denitrification apparatus having an anoxic zone before an aeration zone, self-generated endogenous organics and/or external carbon sources are used as the carbon source. The organic carbon source within the wastewater 102 is consumed in the aerobic zone. Release of ammonium in the anoxic zone may result if only self-generated endogenous organics are used as carbon sources.

After the wastewater 102 has been screened, the secondary treatment apparatus 115, 215 is designed to mix the wastewater 102 and the present cationic clay composition in a way such that suspended biomass floc out of suspension and that increases oxygen levels for the microorganisms within the sludge water 117 that are breaking down the biomass. Secondary treatment of the wastewater 102 with the cationic clay composition preferably takes place in an oxidation ditch reactor 115 or a sequence batch reactor 215. Alternatively, other secondary treatments may be utilized, including, but not limited to, an extended aeration reactor, a contact stabilization reactor, a fixed film reactor, a plug flow reactor, or any combination thereof. Secondary treatment removes dissolved, suspended, and colloidal biomass that may have escaped preliminary treatment. Removal of dissolved, suspended, and colloidal biomass during secondary treatment is accomplished via microbial processes that consume the organic waste and convert it into carbon dioxide, water, and energy. Removal of the remaining organic matter during secondary treatment protects the oxygen balance of receiving waters 104, which prevents foul odors and fish kills. The three basic biological treatment methods are trickling filter, activated sludge 124 process, and oxidation pond. The focus of the present disclosure is on wastewater treatment systems that employ the activated sludge 124 process. When the cationic clay composition is added during agitation, it is preferably added in powder form; however, the cationic clay composition may also be added in slurry form.

The main design and operating parameters of activated sludge wastewater treatment systems include the hydraulic retention time (HRT), the sludge 124 recycle rate (r), the sludge 124 retention time (SRT), mixed liquor suspended solids (MLSS), the volumetric organic load (VOL), the food microorganism ratio (F/M), the sludge 124 settling properties (sludge 124 volumetric index (SVI)), the characteristics of floc, and the concentration of dissolved oxygen (DO). The HRT is one of the main parameters in the activated sludge 124 system as it is implicitly associated with the organic load applied and the reactor volume. The HRT affects the costs of implementation, operation, and maintenance. The VOL and F/M ratio represent the organic load applied to the system in terms of the reactor volume and the active biomass, respectively. The F/M ratio can create conditions that favor the predominance of filamentous organisms that affect the settling properties of the sludge 124, causing brown foam in the aeration tank and deterioration in effluent quality. The SRT, which is used for the design and operation of the system, is the most important parameter in maintaining the MLSS concentration, as it influences the evolution of the biochemical transformation processes and is related to the rate of growth of microorganisms, because only the microorganisms capable of breeding in this time can survive and enrich the system. The SRT can affect the floc structure and the settling properties of the sludge 124.

The MLSS represents the amount of biomass in the system. The SVI indicates the separation efficiency of the biomass of the mixed liquor. The settling properties of sludge 124 formed during the activated sludge 124 process are essential for the clarification of the effluent. High values of SVI are associated with sludge 124 bulking and foam problems that affect the effluent quality. The solids concentration in the secondary settler affect the solids concentration in the recirculation sludge 124, although if the sludge 124 is concentrated, the recycle rate requirements will be lower in order to guarantee the MLSSV in the SR, which is also affected by the SRT. The DO concentration is important in the development of processes that occur in the activated sludge 124 systems. The main oxygen requirements are determined by oxidation of organic matter and ammonia through heterotrophic and autotrophic microorganisms respectively. Low levels of DO can affect the sludge 124 settling properties and the metabolic activity of microorganisms, generating an incomplete removal of substrate, which is reflected in the poor effluent quality. The biological oxygen demand (BOD) is directly related to the DO and refers to the amount of oxygen that would be consumed if all the organics in one-liter of wastewater were oxidized by bacteria and protozoa. When BOD levels are high, DO levels decrease because the oxygen that is available in the wastewater is being consumed by bacteria. Activated sludge is often returned at a rate of approximately 1,000 to 1,500 mg/L MLSS; however, this may be higher or lower depending on the number of biomass within the wastewater, HRT, SRT, and other variables.

An oxidation ditch system 100 may be defined as a modified activated sludge wastewater treatment process comprising an oxidation ditch reactor 115 as its secondary treatment apparatus that enables the system to use long solids retention times (SRTs) to remove biomass. Oxidation ditch reactors 115 typically comprise a basin having a ring, oval or horseshoe shape. This basin may have a single or multichannel configuration. Wastewater 102 is flowed through the basin and continuously recirculated, allowing some wastewater 102 to proceed to the next step in the treatment process. Mounted aerators (mechanical aerators/brushes) circulate the wastewater 102 within the basin as well as facilitate oxygen transfer and aeration. Wastewater 102 may be circulated at a rate of 0.8 to 1.2 ft/s within the oxidation ditch reactor 115. Activated sludge 124 recycle rates for an oxidation ditch reactor 115 often range from 75 to 150 percent, and the MLSS concentration often ranges from 1,500 to 5,000. An oxidation ditch typically has a solid retention time of approximately 4 to 48 days. The BOD loading rate is typically 1.6×10⁵ to 4.7×10⁷ mg/1000 liters, and the HRT range is between 6 and 30 hours.

A sequence batch system 200 may be defined as a modified activated sludge wastewater treatment process comprising at least one aeration tank (sequence batch reactor 215) as its secondary treatment apparatus that bubbles oxygen through wastewater 102 and activated sludge 124 in batches to reduce dissolved, suspended, and colloidal biomass. The cycle for each tank in a typical sequence batch system 200 is divided into five discrete periods: fill, react, settle, draw, and idle, so equalization, aeration, and clarification can all be achieved using a single batch reactor 215. However, two or more batch reactors 215 may be used in sequence to optimize results. Each tank of the system is filled with a batch of wastewater 102 during a discrete period of time and then operated as a batch reactor 215. After desired treatment, the mixed liquor is allowed to settle, and the clarified supernatant 122 is then drawn from the tank. The F/M ratio of a sequence batch system 200 is typically between 0.15 to 0.6 lbs. BOD/lb. MLSS. The treatment cycle duration ranges from 4 to 24 hours. The MLSS at low water levels ranges from approximately 2,000 to 4,000 mg/L. The HRTs range from 6 to 14 hours; however, HRTs may be longer or shorter depending on the application.

In one optional embodiment, the system may further comprise a sedimentation apparatus 120 that allows wastewater 102 and/or sludge water 117 to clarify via the settling of dissolved, suspended, and colloidal biomass. The settling of the dissolved, suspended, and colloidal biomass in a modified activated sludge wastewater treatment process results in clearer effluent 132 and/or supernatant 122 as well as activated sludge 124. The system may use a sedimentation apparatus 120 before secondary treatment to remove as much settable and floatable material as possible from wastewater 102. The system may also use a sedimentation apparatus 120 after secondary treatment to produce a clear supernatant 122 that may undergo disinfection and ultimately discharge into the receiving waters 104. The activated sludge 124 that settles at the bottom of the sedimentation apparatus 120 may be reused in the activated sludge 124 process to provide food to the microorganisms of the system. Alternatively, the activated sludge 124 may be wasted via digestion and ultimately removed from the wastewater treatment system.

After secondary treatment, the supernatant 122 may be treated by the disinfection apparatus 130 to create a treated effluent 132, which may be removed from the wastewater treatment plant by returning the treated effluent 132 to the receiving waters 104. The supernatant 122 may be treated by the disinfection apparatus 130 using several techniques, including, but not limited to, chlorination, ozonation, and ultraviolet disinfection. In an optional embodiment, treatment of wastewater 102 via chlorine is used because it can be supplied in many forms (chlorine gas, hypochlorite solutions, and other solid or liquid chlorine compounds), is more cost effective than other disinfection methods, has a flexible dosing control, and can eliminate noxious odors. In an optional embodiment of a disinfection apparatus 130 that disinfects via chlorination, the disinfection apparatus may comprise a chlorine diffuser, contact basin, and dechlorination diffuser (typically using sulfur dioxide). The supernatant 122 and chlorine gas are mixed at the chlorine diffuser before flow through the contact basin. In an optional embodiment, the contact basin is designed such that there are no flow dead zones. Once the chlorinated supernatant 122 reaches the end of the contact basin, the dechlorination diffuser may be used to mix sulfur dioxide, sodium bisulfate, and/or sodium metabisulfite with the chlorinated supernatant 122 to remove any residual chlorine and produce treated effluent 132 that may be safely released to the receiving waters 104.

FIG. 3 provides a flow chart 300 illustrating certain method steps that may be used to carry out the process of treating wastewater 102 in a system comprising an oxidation ditch reactor 115, as illustrated in FIG. 1, using a plurality of injection sites 107. Step 305 indicates the beginning of the method. During step 310, an operator provides a cationic mineral composition comprising at least 70 weight percent kaolinite and between 5 and 25 weight percent titanium dioxide having an average particle size between 25 and 150 microns. Preferably, the composition comprises at least 90 weight percent kaolinite and between 5 and 10 weight percent titanium dioxide. In addition, the composition preferably has an average particle size between 25 and 75 microns. The composition provided functions as a flocculant to flocculate out biomass suspended in wastewater 102. During step 315, the operator may optionally obtain a coagulating polymer that may be used to create a precipitate in conjunction with the cationic clay composition. Wastewater 102 may then be collected by the wastewater collection apparatus 105 during step 317, and the operator may decide whether it is necessary to add the cationic clay composition to the wastewater 102 during step 320. The operator may take an action based on this determination during step 325. If the operator determines that it is not necessary to add the cationic clay composition to the wastewater 102, the operator may proceed to step 335. If the operator determines it is necessary to add the cationic clay composition to the wastewater 102, the operator may proceed to step 330, wherein the operator may add the cationic clay composition to the wastewater 102 after collection. Reasons an operator may want to add the cationic clay composition to wastewater 102 after collection in an oxidation ditch system 100 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Once the cationic clay composition has been added to the wastewater 102, the method may proceed to step 335.

After collection, the wastewater 102 may be screened by the preliminary treatment apparatus 110 during step 335. The wastewater 102 may then be agitated via the oxidation ditch reactor 115 during step 340, and the operator may add the cationic clay composition to the wastewater 102 during step 342 to form sludge water 117. Addition of the cationic clay composition to wastewater 102 during secondary treatment increases the settling of biomass while being agitated within the oxidation ditch reactor 115. This reduces the turbidity of the wastewater 102 before clarification and may reduce the amount of chlorine necessary to treat the supernatant 122 during the disinfection process due to lower amounts of biomass in the supernatant 122. In some optional embodiments, the coagulating polymer may be added at this point to further increasing the settling of biomass. Once agitated, the sludge water 117 may be clarified during step 345 such that the cationic clay composition and biomass floc out of the sludge water 117, thus forming a clear supernatant 122 and activated sludge 124. During step 350, the operator may add the coagulating polymer to the sludge water 117 within the clarifier to help the cationic clay composition to floc out the biomass within the sludge water 117. In some optional embodiments, the operator may add the cationic clay composition during clarification to prevent ashing (floating biomass) within the clarifier, resulting in an even clearer supernatant 122 and further reducing the amount of chlorine needed for disinfection. Alternatively, an operator may skip addition of either the coagulating polymer or cationic clay composition to the sludge water 117 within the clarifier. The activated sludge 124 may be collected by the operator and the supernatant 122 siphoned off and sent to disinfection during step 355. The method may then proceed to steps 360 and 390.

The operator may determine whether it is necessary to return a portion of the activated sludge 124 to the wastewater 102 before secondary treatment during step 360. The operator may take an action based on this determination during step 365. If the operator determines that it is not necessary to return activated sludge 124 to the wastewater 102 prior to secondary treatment, the operator may proceed to step 380. If the operator determines it is necessary to return a portion of the activated sludge 124 to the wastewater 102 prior to secondary treatment, the operator may proceed to step 370, wherein the operator may collect the activated sludge 124 to be returned to the wastewater 102. The operator may decide whether it is necessary to add the cationic clay composition to the returning activated sludge 124A during step 372. The operator may take an action based on this determination in step 374. If the operator determines that it is not necessary to add the cationic clay composition to the returning activated sludge 124A, the operator may proceed to step 378. If the operator determines it is necessary to add the cationic clay composition to the returning activated sludge 124A, the operator may proceed to step 376, wherein the operator may add the cationic clay composition to the returning activated sludge 124A. Reasons an operator may want to add the cationic clay composition to the returning activated sludge 124A in an oxidation ditch system 100 includes controlling odor and reducing the need for coagulating polymer. It may also reduce the need to centrifuge the returning activated sludge 124A by increasing the number of quality biosolid and reducing the number of decants due to a higher amount of oxygen dissolved in the wastewater 102. The operator may add the returning activated sludge 124A to the wastewater 102 during step 378. Once a portion of the activated sludge 124 has been added to the wastewater 102, the operator may proceed to steps 380.

During step 380, the oxidation ditch system 100 may digest any activated sludge 124 that was not returned to the wastewater 102. The operator may decide whether it is necessary to add the cationic clay composition to the wasted activated sludge 124B during step 382. The operator may take an action based on this determination in step 384. If the operator determines that it is not necessary to add the cationic clay composition to the wasted activated sludge 124B, the operator may proceed to step 388. If the operator determines it is necessary to add the cationic clay composition to the wasted activated sludge 124B, the operator may proceed to step 386, wherein the operator may add the cationic clay composition to the wasted activated sludge 124B. Reasons an operator may want to add the cationic clay composition to the wasted activated sludge 124B during digestion includes reducing the need to centrifuge the wasted activated sludge 124B by increasing the number of quality biomass and reducing the number of decants due to a higher amount of oxygen dissolved in the wastewater 102. This should result in a decrease in cost to digest the biomass compared to current methods. The operator may remove the wasted activated sludge 124B from the oxidation ditch system 100 after digestion during step 388. Once the wasted activated sludge 124B has been removed from the oxidation ditch system 100, the method may proceed to the terminate method step 399.

During step 390, the supernatant 122 siphoned off during step 355 may be disinfected by the disinfection apparatus 130 to form treated effluent 132. The operator may determine whether to add the cationic clay composition to the supernatant 122 within the disinfection apparatus 130 during step 392. The operator may take an action based on this determination in step 394. If the operator determines that it is not necessary to add the cationic clay composition to the supernatant 122 within the disinfection apparatus 130, the operator may proceed to step 398. If the operator determines it is necessary to add the cationic clay composition to the supernatant 122 within the disinfection apparatus 130, the operator may proceed to step 396, wherein the operator may add the cationic clay composition to the supernatant 122 within the disinfection apparatus 130. Reasons an operator may want to add the cationic clay composition to the supernatant 122 within the disinfection apparatus 130 includes further decreasing chlorine usage for disinfection and decreased turbidity, which may further lower the costs of operation. The treated effluent 132 may then be added to the receiving waters 104 during step 398. Once the treated effluent has been added to the receiving waters 104, the method may proceed to the terminate method step 399.

FIG. 4 provides a flow chart 400 illustrating certain method steps that may be used to carry out the process of treating wastewater 102 in a system comprising a sequence batch reactor 215, as illustrated in FIG. 2, using a plurality of injection sites 107. Step 405 indicates the beginning of the method. During step 410, an operator provides a cationic mineral composition comprising at least 70 weight percent kaolinite and between 5 and 25 weight percent titanium dioxide having an average particle size between 25 and 150 microns. Preferably, the composition comprises at least 90 weight percent kaolinite and between 5 and 10 weight percent titanium dioxide. In addition, the composition preferably has an average particle size between 25 and 75 microns. The composition provided functions as a flocculant to flocculate out biomass suspended in wastewater 102. During step 415, the operator may optionally provide a coagulating polymer that may be used to form a precipitate in conjunction with the cationic clay composition. Wastewater 102 may then be collected by the wastewater collection apparatus 105, and the operator may decide whether it is necessary to add the cationic clay composition to the wastewater 102 during step 420. The operator may take an action based on this determination during step 425. If the operator determines that it is not necessary to add the cationic clay composition to the wastewater 102, the operator may proceed to step 435. If the operator determines it is necessary to add the cationic clay composition to the wastewater 102, the operator may proceed to step 430, wherein the operator may add the cationic clay composition to the wastewater 102 after collection. Reasons an operator may want to add the cationic clay composition to wastewater 102 after collection in a sequence batch system 200 includes reducing ammonia compounds earlier in the treatment process. This in turn reduces hydrogen sulfide, which could result in less infrastructure corrosion. Additionally, introduction of the cationic clay composition at this point may reduce the number of large solids suspended in the wastewater 102, thus increasing the effectiveness of preliminary treatment and reducing the need for maintenance. Once the cationic clay composition has been added to the wastewater 102, the method may proceed to step 435.

After collection, the wastewater 102 may be screened by the preliminary treatment apparatus 110 during step 435. The wastewater 102 may then be agitated via the sequence batch reactor 215 during step 440, and the operator may add the cationic clay composition to the wastewater 102 during step 445 to form sludge water 117. Addition of the cationic clay composition to wastewater 102 to form sludge water 117 within a sequence batch reactor 215 promotes the settling out of biomass to form the activated sludge 124. The addition may also promote the settling out of “straggler” biomass still suspended in any supernatant 122 just prior to leaving the sequence batch reactor 215. Reduction in straggler biomass reduces the turbidity of the resulting supernatant 122 before sanitation and generally reduces the amount of chlorine necessary to treat the supernatant 122 during the disinfection process due to lower amounts of biomass suspended within the supernatant 122. If chlorine rates are elevated out of necessity, there is an increased risk of the system experiencing an increase in trichloromethanes, which adversely effects effluent quality due to increased turbidity. In some optional embodiments, the coagulating polymer may be added to the sludge water 117 within the sequence batch reactor 215 to further promote the settling of floc to create activated sludge 124 and supernatant 122. The activated sludge 124 may be collected by the operator and the supernatant 122 siphoned off and sent to disinfection during step 455. The method may then proceed to steps 460 and 480.

During step 460, the operator may decide whether it is necessary to add the cationic clay composition to the activated sludge 124 prior to digestion. The operator may take an action based on this determination during step 462. If the operator determines that it is not necessary to add the cationic clay composition to the activated sludge 124, the operator may proceed to step 466. If the operator determines it is necessary to add the cationic clay composition to the activated sludge 124, the operator may do so in step 464. Reasons an operator may want to add the cationic clay composition to the activated sludge 124 prior to digestion includes obtaining biosolid quality sludge 124 without the need of centrifuging. It may also reduce the amount of coagulating polymer required to achieve biosolid quality sludge 124, reducing the overall cost of digestion. Additionally, introduction of the cationic clay composition at this point may increase the holding time of the activated sludge 124, which may assist in reducing the overall transportation costs of disposal. Once the cationic clay composition has been added to the activated sludge 124, the method may proceed to step 466, wherein the operator may optionally add the coagulating polymer to the activated sludge 124. The activated sludge 124 may then be digested during step 468, and the operator may decide whether it is necessary to add additional cationic clay composition to the digestion process during step 470.

During step 472, the operator may take an action based on the determination of step 470. If the operator determines that it is not necessary to add the cationic clay composition to the digestion process, the operator may proceed to step 476. If the operator determines it is necessary to add the cationic clay composition to the activated sludge 124 during digestion, the operator may proceed to step 474, wherein the operator may add the cationic clay composition to the activated sludge 124. Reasons for adding the cationic clay composition to the activated sludge 124 undergoing digestion include the same reasons one might add the cationic clay composition prior to digestion. The operator may remove the activated sludge 124 from the sequence batch system 200 after digestion during step 476. Once the sludge 124 has been removed from the sequence batch system 200, the operator may dispose of the sludge 124 during step 478. Once the wasted activated sludge 124B has been disposed of, the method may proceed to the terminate method step 490.

During step 480, the supernatant 122 siphoned off during step 455 may be disinfected by the disinfection apparatus 130 to create treated effluent 132. The operator may determine whether to add the cationic clay composition to the supernatant 122 within the disinfection apparatus 130 during step 482. The operator may take an action based on this determination in step 484. If the operator determines that it is not necessary to add the cationic clay composition to the supernatant 122 within the disinfection apparatus 130, the operator may proceed to step 488. If the operator determines it is necessary to add the cationic clay composition to the supernatant 122 within the disinfection apparatus 130, the operator may proceed to step 486, wherein the operator may add the cationic clay composition to the supernatant 122 within the disinfection apparatus 130. Reasons an operator may desire to add the cationic clay composition to the supernatant 122 within the disinfection apparatus 130 includes further decreasing chlorine usage for disinfection and decreased turbidity, which may further decrease the costs of operation. The treated effluent 132 may then be added to the receiving waters 104 during step 488. Once the treated effluent has been added to the receiving waters 104, the method may proceed to the terminate method step 490.

In order to determine the effectiveness of the present composition in treating wastewater in accordance with the methods described herein, settleability tests were conducted on the wastewater before and after treatment with the cationic clay composition. A settleability test is an analysis of the settling characteristics of the activated sludge mixed liquor suspended solids (MLSS). To conduct the tests, a two liter graduated cylinder is filled to the 1000 ml mark with a representative wastewater sample from a wastewater plant and allowed to settle. An amount of cationic clay composition was added to each sample and the samples were allowed to settle. Settling rates are tested at one-minute intervals for ten minutes. The cationic clay composition had a particle size ranging between 25 and 75 microns. The composition comprised approximately 93% kaolinite and 7% titanium dioxide. Approximately 0.5 grams of cationic clay composition was added to and mixed into each 1000 ml wastewater sample. The results of the test are shown in Table 1 below.

TABLE 1
Settleability test results.

| | Mixed Liquor Suspended Solids (MLSS) | | | | | | | |
|---|---|---|---|---|---|---|---|---|
| | No | | SBR | | SBR | | | |
| Min- | Treat- | | Batch | | Batch | | | |
| ute | ment | Rate | #1 | Rate | #2 | Rate | OD | Rate |
| 1 | 920 | 8% | 800 | 20% | 820 | 18% | 930 | 7% |
| 2 | 910 | 9% | 620 | 38% | 670 | 33% | 770 | 23% |
| 3 | 880 | 12% | 540 | 46% | 580 | 42% | 650 | 35% |
| 4 | 850 | 15% | 500 | 50% | 530 | 47% | 580 | 42% |
| 5 | 820 | 18% | 460 | 54% | 500 | 50% | 540 | 46% |
| 6 | 790 | 21% | 430 | 57% | 470 | 53% | 500 | 50% |
| 7 | 760 | 24% | 420 | 58% | 450 | 55% | 480 | 52% |
| 8 | 740 | 26% | 400 | 60% | 430 | 57% | 450 | 55% |
| 9 | 710 | 29% | 380 | 62% | 410 | 59% | 440 | 56% |
| 10 | 690 | 31% | 370 | 63% | 370 | 63% | 420 | 58% |

The units of MLSS are mg/L. The results show settleability rates for wastewater that has not been treated with the cationic clay composition and for wastewater after treatment with the composition. Two wastewater samples (batch #1 and batch #2) were taken from a sequence batch reactor (SBR) after treatment, and one sample was taken from an oxidation ditch (OD) reactor after treatment. In the wastewater treatment methods described herein, it is important for the activated sludge to settle out quickly in order to achieve desired wastewater treatment parameters. The above samples were allowed to settle for ten minutes. As shown in Table 1, the untreated wastewater sample achieved only a 31% settling rate after ten minutes, but the treated wastewater samples achieved settling rates over 50%, and ranged from 58% (for the oxidation ditch (OD) reactor 115) to 63% (for the sequence batch reactor (SBR) 215 samples) after only ten minutes.

The results presented in Table 1 illustrate that the present cationic clay composition, when used as a flocculant in wastewater treatment, functions as a rapid reacting agent that helps to increase settleability within a very short period of time. This action may aid wastewater treatment plants that regularly have trouble either reaching a more controlled MLSS result or achieving a better settling rate. These issues are common in aging wastewater treatment plants that have “old sludge” issues. If MLSS results and settling rates are not sufficiently controlled, the clarification process may be adversely affected due to both straggler and pin-floc escaping, which may increase the required chlorine feed rate. If chlorine rates must be increased in the process, there is a high chance of an increase in trichloromethanes, which may cause the effluent to become excessively turbid. In this case, the effluent may go into a “reject” status. Thus, it is important for operators of the process to maintain control of MLSS and settling rates during normal operation, which may be achieved due to the rapid settleability rates provided by the present composition.

Although the compositions, systems, and processes of the present disclosure have been discussed for use within the wastewater treatment field, one of skill in the art will appreciate that the inventive subject matter disclosed herein may be utilized in other fields or for other applications in which wastewater treatment is needed. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and process stages which have been described and illustrated in order to explain the nature of this inventive subject matter can be made without departing from the principles and scope of the inventive subject matter.

What is claimed is:
1) A cationic mineral composition for treating wastewater, said composition comprising at least 70 weight percent kaolinite and between 5 and 25 weight percent titanium dioxide, wherein the composition has an average particle size of 25 to 150 microns, and wherein the composition acts as a flocculant.
2) The composition of claim 1, wherein the average particle size is 25 to 75 microns.
3) The composition of claim 1, wherein the kaolinite has a pKₐ value of about 4.5 along the edge of its particles and a pKₐ value of about 6.5 on the face of its particles.
4) The composition of claim 1, wherein the composition comprises at least 90 weight percent kaolinite and between 5 and 10 weight percent titanium dioxide.
5) A clay slurry composition for treating wastewater, said slurry comprising at least 80 combined weight percent kaolinite and titanium dioxide and up to 20 weight percent water, wherein the kaolinite and titanium dioxide have an average particle size of 25 to 150 microns, and wherein the composition acts as a flocculant.
6) The slurry of claim 5, wherein the average particle size is 25 to 75 microns.
7) The slurry of claim 5, wherein the kaolinite has a pKₐ value of about 4.5 along the edge of its particles and a pKₐ value of about 6.5 on the face of its particles.
8) The slurry of claim 5, wherein the slurry comprises at least 70 weight percent kaolinite and up to 10 weight percent titanium dioxide.
9) A method for treating wastewater, said method comprising the steps of:
   providing a cationic mineral composition comprising at least 70 weight percent kaolinite and between 5 and 25 weight percent titanium dioxide, wherein the composition has an average particle size of 25 to 150 microns,
   collecting wastewater containing suspended biomass,
   adding the cationic mineral composition to the wastewater in an amount sufficient to promote flocculation of the biomass contained in the wastewater, wherein the floc formed during flocculation contains at least 50% of the biomass within 10 minutes of adding the cationic mineral composition, and
   removing the floc from the wastewater.
10) The method of claim 9, wherein the step of removing the floc from the wastewater comprises allowing the floc to settle in the form of activated sludge and removing the activated sludge from the wastewater.
11) The method of claim 9, wherein the cationic mineral composition is mixed with the wastewater at a rate within a range of 0.3 to 2 grams per liter of wastewater.
12) The method of claim 9, further comprising the steps of:
   treating the wastewater containing the cationic mineral composition with a secondary treatment apparatus to form activated sludge,
   removing the activated sludge from the wastewater to form supernatant, and
   disinfecting the supernatant to form effluent.
13) The method of claim 12, wherein said secondary treatment apparatus comprises at least one of an oxidation ditch reactor and a sequence batch reactor.
14) The method of claim 12, further comprising the step of:
   returning said activated sludge to said wastewater prior to treatment with said secondary treatment apparatus.
15) The method of claim 14, wherein said activated sludge is returned at a rate of at least 1.0 gram per liter of mixed liquor suspended solids.
16) The method of claim 12, further comprising the step of:
   digesting said activated sludge removed from said wastewater.
17) The method of claim 9, further comprising the step of:
   forming a slurry comprising the cationic mineral composition and water, wherein the step of adding the cationic mineral composition to the wastewater comprises adding the slurry to the wastewater.
18) The method of claim 17, wherein said slurry comprises at least eighty weight percent cationic mineral composition and up to twenty weight percent water.

What is claimed is:

1) A cationic mineral composition for treating wastewater, said composition comprising at least 70 weight percent kaolinite and between 5 and 25 weight percent titanium dioxide, wherein the composition has an average particle size of 25 to 150 microns, and wherein the composition acts as a flocculant.

2) The composition of claim 1, wherein the average particle size is 25 to 75 microns.

3) The composition of claim 1, wherein the kaolinite has a pKₐ value of about 4.5 along the edge of its particles and a pKₐ value of about 6.5 on the face of its particles.

4) The composition of claim 1, wherein the composition comprises at least 90 weight percent kaolinite and between 5 and 10 weight percent titanium dioxide.

5) A clay slurry composition for treating wastewater, said slurry comprising at least 80 combined weight percent kaolinite and titanium dioxide and up to 20 weight percent water, wherein the kaolinite and titanium dioxide have an average particle size of 25 to 150 microns, and wherein the composition acts as a flocculant.

6) The slurry of claim 5, wherein the average particle size is 25 to 75 microns.

7) The slurry of claim 5, wherein the kaolinite has a pKₐ value of about 4.5 along the edge of its particles and a pKₐ value of about 6.5 on the face of its particles.

8) The slurry of claim 5, wherein the slurry comprises at least 70 weight percent kaolinite and up to 10 weight percent titanium dioxide.

9) A method for treating wastewater, said method comprising the steps of:
providing a cationic mineral composition comprising at least 70 weight percent kaolinite and between 5 and 25 weight percent titanium dioxide, wherein the composition has an average particle size of 25 to 150 microns,
collecting wastewater containing suspended biomass,
adding the cationic mineral composition to the wastewater in an amount sufficient to promote flocculation of the biomass contained in the wastewater, wherein the floc formed during flocculation contains at least 50% of the biomass within 10 minutes of adding the cationic mineral composition, and
removing the floc from the wastewater.

10) The method of claim 9, wherein the step of removing the floc from the wastewater comprises allowing the floc to settle in the form of activated sludge and removing the activated sludge from the wastewater.

11) The method of claim 9, wherein the cationic mineral composition is mixed with the wastewater at a rate within a range of 0.3 to 2 grams per liter of wastewater.

12) The method of claim 9, further comprising the steps of:
treating the wastewater containing the cationic mineral composition with a secondary treatment apparatus to form activated sludge,
removing the activated sludge from the wastewater to form supernatant, and
disinfecting the supernatant to form effluent.

13) The method of claim 12, wherein said secondary treatment apparatus comprises at least one of an oxidation ditch reactor and a sequence batch reactor.

14) The method of claim 12, further comprising the step of:
returning said activated sludge to said wastewater prior to treatment with said secondary treatment apparatus.

15) The method of claim 14, wherein said activated sludge is returned at a rate of at least 1.0 gram per liter of mixed liquor suspended solids.

16) The method of claim 12, further comprising the step of:
digesting said activated sludge removed from said wastewater.

17) The method of claim 9, further comprising the step of:
forming a slurry comprising the cationic mineral composition and water, wherein the step of adding the cationic mineral composition to the wastewater comprises adding the slurry to the wastewater.

18) The method of claim 17, wherein said slurry comprises at least eighty weight percent cationic mineral composition and up to twenty weight percent water.
